(19) United States
(12) Patent Application Publication
(10) Pub. No.: US 2018/0237137 A1
(43) Pub. Date: Aug. 23, 2018

(54) Voice Activated Unmanned Aerial Vehicle (UAV) Assistance System

(71) Applicant: Wal-Mart Stores, Inc., Bentonville, AR (US)

(72) Inventors: David G. Tovey, Rogers, AR (US); John Jeremiah O'Brien, Farmington, AR (US); Todd Davenport Mattingly, Bentonville, AR (US)

(21) Appl. No.: 15/879,591

(22) Filed: Jan. 25, 2018

Related U.S. Application Data
(60) Provisional application No. 62/461,911, filed on Feb. 22, 2017.

(51) Int. Cl. B64C 39/02; G05D 1/00; G05D 1/10; B64D 47/08

(52) U.S. Cl. CPC B64C 39/024; G05D 1/0088; G05D 1/101; B64C 2201/127; B64C 2201/141; B64C 2201/12; B64D 47/08

(57) ABSTRACT

Described in detail herein is a voice activated UAV assistance system. A computing system can receive a request for assistance from a mobile device via one or more wireless access points. The computing system can estimate and track a current location of the mobile device based on an interaction between the mobile device and the one or more wireless access points. A UAV can receive, the request for assistance and the current location of the mobile device from the computing system. The UAV can autonomously navigate to the current location of the mobile device. The UAV can receive a voice input of a user associated with the mobile device via the microphone. The UAV can determine the voice input is associated with a set of physical objects disposed in the facility. The UAV can autonomously guiding the user to an object locations physical objects in the facility.

### CROSS-REFERENCE TO RELATED PATENT APPLICATIONS

This application claims priority to U.S. Provisional Application No. 62/461,911 filed on Feb. 22, 2017, the content of which is hereby incorporated by reference in its entirety.

### BACKGROUND

Receiving assistance in a large facility can be a slow and error prone process. A facility may not have enough resources to provide assistance to users in the facility.

### BRIEF DESCRIPTION OF DRAWINGS

Illustrative embodiments are shown by way of example in the accompanying drawings and should not be considered as a limitation of the present disclosure:

FIG. 1 illustrate a mobile device in accordance with an exemplary embodiment;

FIG. 2 is a block diagram illustrating an autonomous Unmanned Aerial Vehicle (UAV) in accordance with an exemplary embodiment;

FIG. 3 illustrates a UAV guiding a user in a facility in accordance with an exemplary embodiment;

FIG. 4 is a block diagram illustrating a voice activated UAV assistance system in accordance with an exemplary embodiment;

FIG. 5 is a block diagram illustrating of an exemplary computing device suitable for use in accordance with an exemplary embodiment; and

FIG. 6 is a flowchart illustrating an exemplary process performed by a voice activated UAV assistance system in accordance with an exemplary embodiment.

### DETAILED DESCRIPTION

Described in detail herein is a voice activated Unmanned Aerial Vehicle (UAV) assistance system. A computing system can receive a request for assistance from a mobile device via one or more wireless access points. Upon receiving the request, the computing system can estimate and track a current location of the mobile device based on an interaction between the mobile device and the one or more wireless access points. A UAV, including an inertial navigation system, a microphone, an image capturing device, and a scanner, can receive the request for assistance and the current estimated location of the mobile device from the computing system. The UAV can receive updates from the computing system associated with the current location of the mobile device as the mobile device moves through the facility. The UAV can autonomously navigate to the current location of the mobile device and can receive a voice input from a user associated with the mobile device via the microphone. The UAV can interact with the computing system to determine the voice input is associated with a set of physical objects disposed in the facility. The UAV can determine object locations for the set of physical objects in the facility. The UAV can autonomously guide the user to object locations for the physical objects in the facility. The UAV can confirm the mobile device remains within a specified distance of the UAV while navigating around the facility, and/or can confirm the physical objects are the determined locations.

In accordance with embodiments of the present disclosure, a voice activated a Unmanned Aerial Vehicle (UAV) assistance system is disclosed. Embodiments of the system can be implemented for autonomous assistance in a facility. The system can include a computing system located in the facility that is configured to receive a request for assistance from a mobile device via one or more wireless access points in communication with the computing system. The computing system is further configured to estimate and track a current location of the mobile device based on the wireless access points that receive wireless transmissions from the mobile device and a signal strength of the received wireless transmissions. The system further includes a UAV including an inertial navigation system, a microphone, an image capturing device, and a scanner. The UAV is configured to receive the request for assistance and the estimated current location of the mobile device from the computing system, receive updates from the computing system associated with the estimated current location of the mobile device as the mobile device moves through the facility, autonomously navigate to the current location of the mobile device, receive a voice input of a user associated with the mobile device via the microphone, interact with the computing system to determine the voice input is associated with a set of physical objects disposed in the facility, determine object locations for the set of physical objects in the facility, autonomously guide the user to an object location of at least a first physical object in the set of physical objects in the facility. The UAV can confirm the mobile device remains within a specified distance of the UAV while navigating to the object location of the at least first physical object. The UAV is further configured to scan, via the scanner, a machine-readable element associated with the at least first physical object and capture, via the image capturing device, an image of the at least first physical object to confirm the first physical object is present at the object location.

The UAV can be configured to autonomously guide the user to another object location associated with at least a second physical object of the set of physical objects in the facility. The UAV confirms the mobile device is within a specified distance of the UAV while navigating to the other object location associated with the second physical object. The UAV can be configured to scan machine-readable elements associated with physical objects from the set of physical objects disposed in a basket associated with a user of the mobile device, capture one or more images of terminals in the facility, calculate an estimated time to process the physical objects associated with the scanned machine-readable elements based on the scanned machine-readable elements and the captured one or more images, and transmit a recommendation of at least one terminal to the mobile device based on the calculated time each terminal would take to process the physical objects associated with the scanned machine-readable elements. The mobile device is configured to display the recommendation of at least one terminal on the interactive display.

The UAV can be configured to scan machine-readable elements associated with physical objects from the set of physical objects disposed in a basket or as the physical objects are disposed in the basket associated with a user of the mobile device, generate a list of physical objects, transmit the list of physical objects to the computing system and/or the mobile device, and interact with the mobile device to complete a transaction associated with the physical objects. For example, the mobile device can be configured to display the list to the user and to provide the user with a selection interface, such that upon selection of the selection interface, the mobile device transmits a message to the UAV that can be utilized by the UAV to complete the transaction.

The UAV can be configured to capture images of the facility while navigating to the object location and detect an accident in the facility based on the images and transmit an alert to the mobile device, in response to detecting the accident. The mobile device can be configured to display the alert on the interactive display. The UAV can modify a route to the object location in response to detecting the accident. The UAV can be configured to pick up the first physical object of the set of physical objects in response to confirming the first physical object is present at the object location and deposit the first physical object in a basket associated with a user of the mobile device.

The request for assistance can includes a first image of a face of the user of the mobile device. The UAV can be configured to capture verification images of faces after autonomously navigating to the estimated current location of the mobile device within the facility and determining whether one of the verification images of the faces captured by the UAV at the estimated current location corresponds to the face of the user of the mobile device who transmitted the request based on a comparison of the verification images with the first image of the face of the user of the mobile device included in the request. The UAV can be configured to identify the user based on the comparison and provide an indicator to the user that the UAV is ready to assist the user. Upon locating the user of the mobile phone, the UAV can be configured to establish a direct communication connection with the mobile device of the user to facilitate receipt and transmission of data between the UAV and the mobile device. The UAV can be configured to determine that the mobile device remains within a specified distance of the UAV while navigating to the object location based on the communication connection.

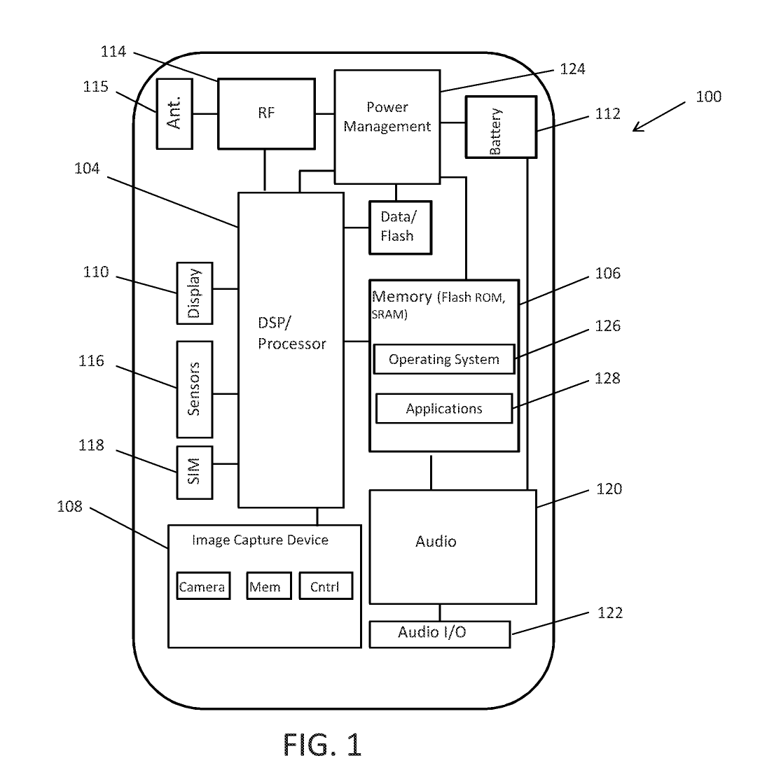

FIG. 1 is a block diagram of a mobile device 100 that can be utilized to implement and/or interact with embodiments of a voice activated a Unmanned Aerial Vehicle (UAV) assistance system. The mobile device 100 can be a smartphone, tablet, subnotebook, laptop, personal digital assistant (PDA), and/or any other suitable mobile device that can be programmed and/or configured to implement and/or interact with embodiments of the voice activated a Unmanned Aerial Vehicle (UAV) assistance system. The mobile device 100 can include a processing device 104, such as a digital signal processor (DSP) or microprocessor, memory/storage 106 in the form a non-transitory computer-readable medium, an image capture device 108, a display 110, a battery 112, and a radio frequency transceiver 114. Some embodiments of the mobile device 100 can also include other common components commonly, such as sensors 116, subscriber identity module (SIM) card 118, audio input/output components 120 and 122 (including e.g., one or more microphones and one or more speakers), and power management circuitry 124.

The memory 106 can include any suitable, non-transitory computer-readable storage medium, e.g., read-only memory (ROM), erasable programmable ROM (EPROM), electrically-erasable programmable ROM (EEPROM), flash memory, and the like. In exemplary embodiments, an operating system 126 and applications 128 can be embodied as computer-readable/executable program code stored on the non-transitory computer-readable memory 106 and implemented using any suitable, high or low level computing language and/or platform, such as, e.g., Java, C, C++, C#, assembly code, machine readable language, and the like. In some embodiments, the applications 128 can include an assistance application configured to interact with the microphone, a web browser application, a mobile application specifically coded to interface with embodiments of the voice activated a Unmanned Aerial Vehicle (UAV) assistance system. While memory is depicted as a single component those skilled in the art will recognize that the memory can be formed from multiple components and that separate non-volatile and volatile memory device can be used.

The processing device 104 can include any suitable single- or multiple-core microprocessor of any suitable architecture that is capable of implementing and/or facilitating an operation of the mobile device 100. For example, to perform an image capture operation, capture a voice input of the user (e.g., via the microphone), transmit messages including a captured image and/or a voice input and receive messages from a computing system and/or a UAV (e.g., via the RF transceiver 114), display data/information including GUIs of the user interface 110, captured images, voice input transcribed as text, and the like. The processing device 104 can be programmed and/or configured to execute the operating system 126 and applications 128 to implement one or more processes to perform an operation. The processing device 104 can retrieve information/data from and store information/data to the storage device 106. For example, the processing device can retrieve and/or store captured images, recorded voice input, voice input transcribed to text, and/or any other suitable information/data that can be utilized by the mobile device and/or the user.

The RF transceiver 114 can be configured to transmit and/or receive wireless transmissions via an antenna 115. For example, the RF transceiver 114 can be configured to transmit data/information, such as one or more images captured by the image capture device and/or transcribed voice input, and/or other messages, directly or indirectly, to one or more remote computing systems and/or UAVs and/or to receive data/information, directly or indirectly, from one or more remote computing systems and/or UAVs. The RF transceiver 114 can be configured to transmit and/or receive information having at a specified frequency and/or according to a specified sequence and/or packet arrangement.

The display 110 can render user interfaces, such as graphical user interfaces to a user and in some embodiments can provide a mechanism that allows the user to interact with the GUIs. For example, a user may interact with the mobile device 100 through display 110, which may be implemented as a liquid crystal touch-screen (or haptic) display, a light emitting diode touch-screen display, and/or any other suitable display device, which may display one or more user interfaces (e.g., GUIs) that may be provided in accordance with exemplary embodiments.

The power source 112 can be implemented as a battery or capacitive elements configured to store an electric charge and power the mobile device 100. In exemplary embodiments, the power source 112 can be a rechargeable power source, such as a battery or one or more capacitive elements configured to be recharged via a connection to an external power supply.

A user can operate the mobile device 100 in a facility, and the graphical user interface can automatically be generated in response executing the assistance application on the mobile device 100. The assistance application can be associated with the facility. The image capturing device 108 can be configured to capture still and moving images and can communicate with the executed application.

The user can request UAV assistance using the graphical user interface generated by the mobile device 100 and/or the microphone of the mobile device 100. The mobile device 100 can transmit the request to a computing system. The request can include an estimated location of the mobile device 100 within the facility and a facial image of the user.

In some embodiments, the facial image of the user can be stored and associated with the executed application. The facial image of the user associated with the application can be transmitted with the request. The mobile device 100 can also trigger the opening of a photo library on the mobile device 100 prior to transmitting the request. The user can select a facial image from the photo library to be transmitted along with the request. The mobile device 100 can also initiate the image capturing device 108 before transmitting the request. The mobile device 100 can capture an facial image of the user using the image capturing device 108 to transmit along with the request.

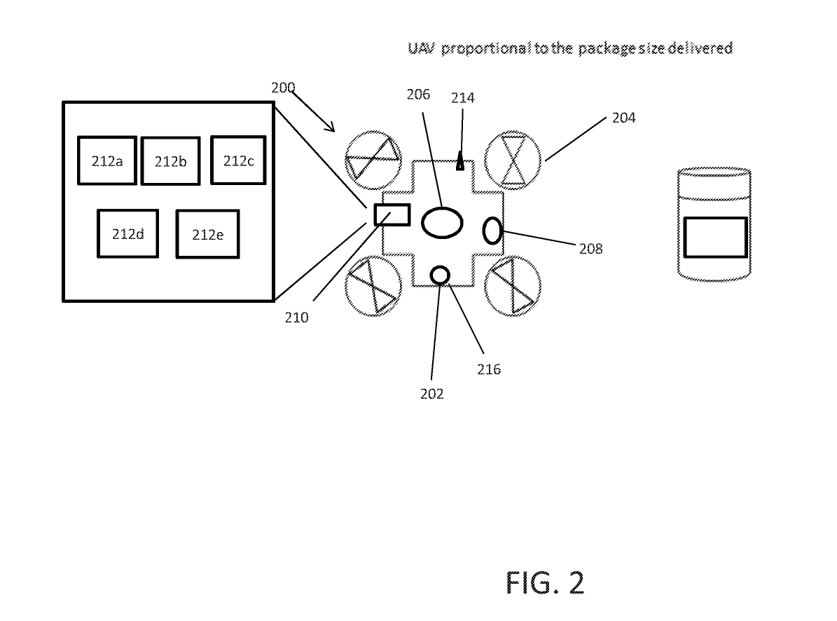

FIG. 2 is a block diagram illustrating an autonomous Unmanned Aerial Vehicle (UAV) in accordance with an exemplary embodiment. The autonomous UAV 200 includes an inertial navigation system. The UAV 200 can include a body 210 and multiple motive assemblies 204. The autonomous UAV can autonomously navigate aerially using motive assemblies 204. In this non-limiting example, the motive assemblies can be secured to the body on the edges of the UAV 200.

The UAV 200 can include an speaker system 206, a microphone 208 and an image capturing device 210. The image capturing device 210 can be configured to capture still or moving images. The microphone 208 can be configured to receive audible (voice) input. The speaker system 206 can be configured to generate audible sounds. The UAV 200 can include a controller 212a, and the inertial navigation system can include a GPS receiver 212b, accelerometer 212c and a gyroscope 212d. The UAV 200 can also include a motor 212e. The controller 212a can be programmed to control the operation of the image capturing device 210, the GPS receiver 212b, accelerometer 212c, a gyroscope 212d, motor 212e, and drive assemblies (e.g., via the motor 212e), in response to various inputs including inputs from the GPS receiver 212b, the accelerometer 212c, and the gyroscope 212d. The motor 212e can control the operation of the motive assemblies 204 directly and/or through one or more drive trains (e.g., gear assemblies and/or belts). The motive assemblies 204 can be but are not limited to wheels, tracks, rotors, rotors with blades, and propellers. The UAV 200 can also include a reader 214. The reader 214 can scan and decode machine-readable elements such as QR codes and barcodes. The UAV 200 can also include a light source 216 configured to generate light effects.

The GPS receiver 212b can be a L-band radio processor capable of solving navigation equations in order to determine a position of the UAV 200 and to determine a velocity and precise time (PVT) by processing a signal broadcast by GPS satellites. The accelerometer 212c and gyroscope 212d can determine the direction, orientation, position, acceleration, velocity, tilt, pitch, yaw, and roll of the UAV 200. In exemplary embodiments, the controller can implement one or more algorithms, such as a Kalman filter, for determining a position of the UAV 200.

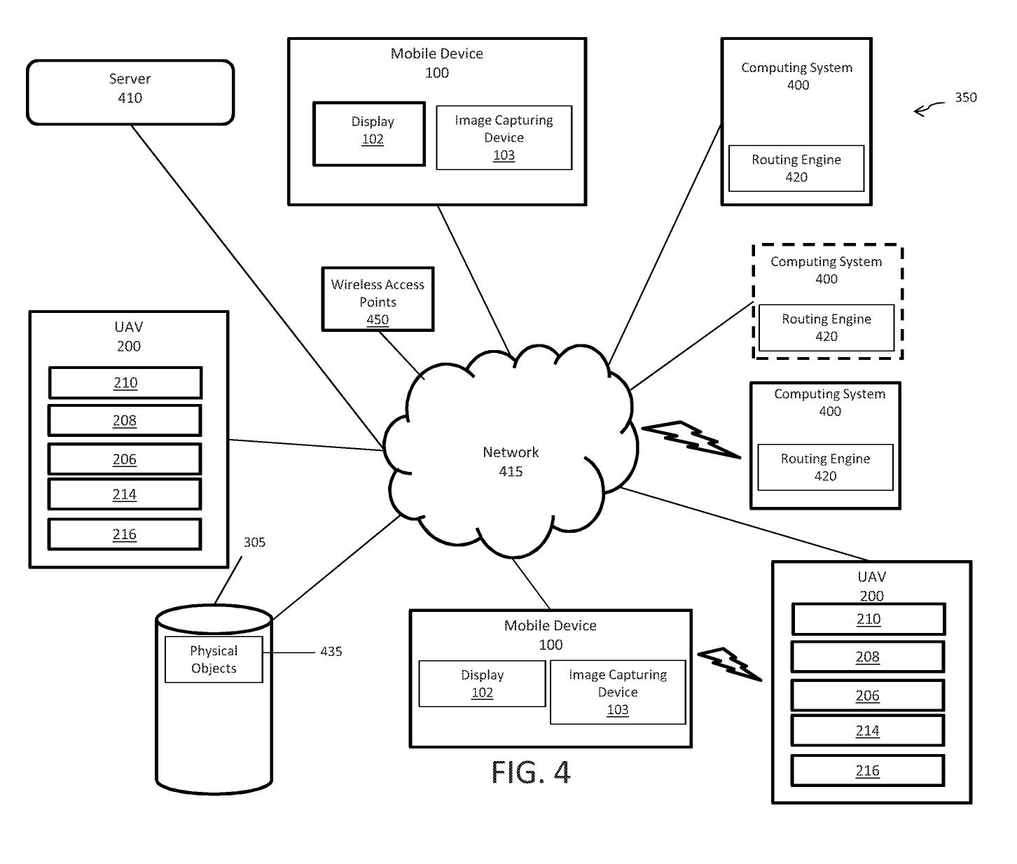

In exemplary embodiments, the UAV 200 can receive instructions from the computing system 400 to provide assistance to a user within the facility. The UAV 200 can also be disposed in the facility. Alternatively, the UAV 200 can be disposed outside the facility. The instructions can include an estimated location of the mobile device belonging to the user within the facility and a facial image of the user. The UAV 200 can navigate to the location of the mobile device. The UAV 200 can scan the location using the image capturing device 210 for the user. The UAV 200 can capture a facial images of a user in the location and compare the captured facial images of the user with the facial images received in the instructions to identify and verify the user. In response to, identifying and verifying the user the UAV 200 can provide an indicator to the user that the UAV 200 is ready to provide assistance. The indicator can be an audible sound generated through the speakers 206 or a light effect generated through the light source 216. The user can audible speak and interact with the UAV 200 via the microphone 210. The UAV 200 can use acoustic and linguistic modeling to execute the speech, voice or audio recognition. The UAV 200 can detect the audio voice input, parse the audio voice input and trigger an action based on the audio input. The UAV 200 can use voice/audio recognition techniques to parse the audio input. In one example, a user can audibly recite physical objects located in the facility to the UAV 200. The UAV 200 detect the voice input and detect the physical objects included in the voice input. The UAV 200 can guiding the user to locations of physical objects within the facility. In some embodiments the user can continue to speak to the microphone of the mobile device associated with the user and the mobile device can transmit a message to the UAV that includes a transcription of the voice input at the mobile phone. The details of the voice activated UAV assistance system will be discussed in further detail with respect to FIG. 4.

In some embodiments the UAV 200 can hover near individuals and can scan an area including the individuals using the image capturing device for user gestures. For example, a user in the area wo needs assistance from the UAV 200 can wave his/her hands back and forth in a crisscross pattern, and upon detecting this gesture, the UAV 200 can move towards the user and output an audible indicator or message (e.g., asking if the user needs assistance). The user can provide an audible response and can again gesture (e.g., by nodding his/her head). In response to receiving confirmation that the user is requesting assistance, the UAV 200 can provide assistance as described herein.

In some embodiments, the UAV 200 can hover in an area, and can scan the area using the image capturing device. The UAV 200 can be configured scan individuals in the area to identify possible security issues or breaches (e.g., by detecting weapons carried by the users). In response to detecting a potential security issue, the UAV can transmit a message to a computing system including an alert, and the computing system can selective transmit the alert to a mobile devices of a group of users and/or can transmit a message including the alert to a government agency (e.g., the police). In response to detecting a potential security issue, the UAV 200 can autonomously transmit a live image feed of the area and the individual carrying the weapon to one or more computing devices to record and/or alert users of the computing device of the potential security issue.

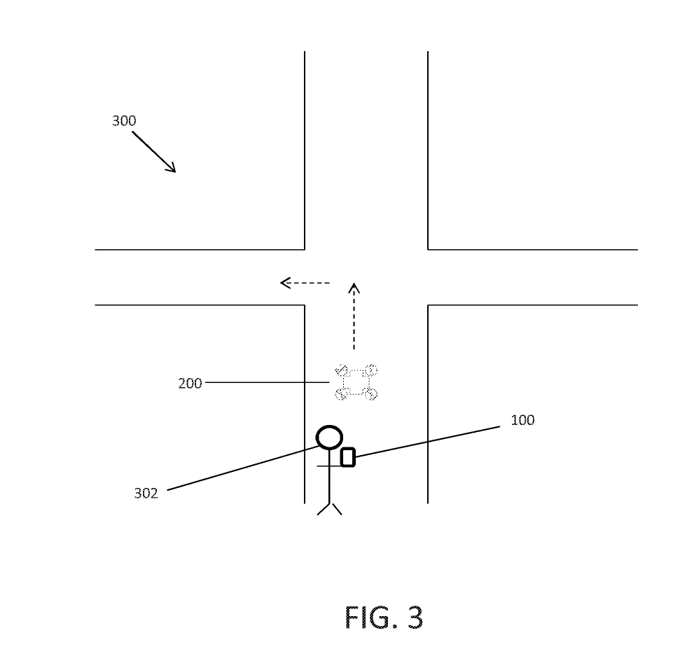

FIG. 3 illustrates a UAV guiding a user in a facility in accordance with an exemplary embodiment. As mentioned above, in one example a UAV 200 can provide a user 302 assistance by guiding the user 302 to the locations of the physical objects within the facility 300. The UAV 200 can navigate in front of the user 302 at a specified speed. The UAV 200 can constantly detect a location of the user's mobile device 100. The UAV 200 can control its speed based on the distance between the UAV 200 and the mobile device 100. In some embodiments, the UAV 200 can generate turn signals, via the light source to indicate the UAV 200 will be turning. The UAV 200 can also constantly scan the facility using the image capturing device to avoid any accidents or dangerous conditions. The UAV 200 can furthermore determine the shortest route to the locations of the physical objects and determine an order to navigate to the physical objects based on the shortest route. The UAV 200 can navigate to the physical objects based on the determined order.

FIG. 4 is a block diagram illustrating voice activated UAV assistance system 450 according to an exemplary embodiment. The voice activated UAV assistance system 450 can include one or more databases 405, one or more servers 410, one or more computing systems 400, mobile devices 100 and UAVs 200. In exemplary embodiments, the computing system 400 can be in communication with the databases 405, the server(s) 410, the mobile devices 100, and the UAVs 200, via a communications network 415. The computing system 400 can implement at least one instance of a routing engine 420. The routing engine 420 is an executable application executed by the computing system 400. The routing engine 420 can implement the process of the voice activated UAV assistance system 450 as described herein.

In an example embodiment, one or more portions of the communications network 415 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 400 includes one or more computers or processors configured to communicate with the databases 405, the mobile devices 100 and the UAVs 200 via the network 315. In one embodiment, computing system 400 is associated with a facility. The computing system 400 hosts one or more applications configured to interact with one or more components of the voice activated UAV assistance system 450. The databases 405 may store information/data, as described herein. For example, the databases 405 can include a physical objects database 435. The physical objects database 435 can store information associated for physical object. The databases 405 and server 410 can be located at one or more geographically distributed locations from each other or from the computing system 400. Alternatively, the databases 405 can be included within server 410 or computing system 400.

In exemplary embodiments, a user can interact with the user interface 103 of the mobile device 100. The user interface 103 can be generated by an application executed on the mobile device 100. The mobile device 100 can transmit a request for a assistance from a UAV from to a computing system 400. The request can include a location of the mobile device 100 and a facial image of the user. The facial image can be an image stored in a mobile device photo library. The facial image can be an image captured by the image capturing device 103. In some embodiments, the mobile device 100 can provide an identifier of the mobile device 100 to the computing system. The computing system 400 can use the identifier to track location of the mobile device 100 within the facility. The mobile device 100 identifier can be one or more of Unique Device ID (UDID), the International Mobile Equipment Identity (IMEI), Integrated Circuit Card Identifier (ICCID) and/or the Mobile Equipment Identifier (MEID). In some embodiments, mobile device 100 can communicate with the computing system 400, via wireless access points 450 disposed throughout the facility. The computing system 400 can detect the location of the mobile device 100 based on the proximity of the mobile device 100 to one or more of the wireless access points. For example, the location can be determined based on which of the wireless access points 450 receive a signal from the mobile device and the signal strength of the signal received by the wireless access points 450. Triangulation based on which of the wireless access points 450 receive the signal and the signal strength can be performed to estimate the location of the mobile device 100.

The computing system 400 can execute the routing engine 420 in response to receiving the request. The routing engine 420 can determine a UAV 200 closest in proximity to the location of the mobile device 100 that is available to assist the user. The routing engine 420 can instruct the UAV 200 to assist the user. The instructions can include a facial image of the user received with the request and an estimated location of the mobile device 100 of the user. The routing engine 420 can periodically or continuously update the UAV 200 of the estimated current location of the mobile device 100 within the facility.

The UAV 200 can navigate to the estimated current location of the mobile device 100. The UAV 200 can scan the location using the image capturing device 210 for the user. The UAV 200 can capture a facial images of a user in the location using the image capturing device 210 and compare the captured facial images of the user with the facial images received in the instructions to identify and verify the user. The UAV 200 can use image analysis and/or machine vision to compare the captured facial image of the user and the facial received by the computing system 400. The UAV 200 can use one or more techniques of machine vision: Stitching/Registration, Filtering, Thresholding, Pixel counting, Segmentation, Inpainting, Edge detection, Color Analysis, Blob discovery & manipulation, Neural net processing, Pattern recognition, Barcode Data Matrix and “2D barcode” reading, Optical character recognition and Gauging/Metrology. In response to, identifying and verifying the user the UAV 200 can provide an indicator to the user that the UAV 200 is ready to provide assistance. The indicator can be an audible sound generated through the speakers 206 or a light effect generated through the light source 216. In the event the UAV 200 is unable to identify and/or verify the user. The UAV 200 can provide a different indicator. The UAV 200 can also transmit an alert to the mobile device 100 to be displayed on the user interface. Furthermore, the UAV 200 can transmit an alert to the computing system 200.

In response to verifying and identifying the user, the user can audible speak and interact with the UAV 200 via the microphone 210. The UAV 200 can detect the audio voice input, parse the audio voice input and trigger an action based on the audio input. The UAV 200 can use voice/audio recognition techniques to parse the audio input. The UAV 200 can use acoustic and linguistic modeling to execute the speech, voice or audio recognition. In some embodiments, the user can speak into the microphone of the mobile device and the mobile device can send a message to the UAV 200 that includes a transcription of the voice input. In some embodiments, the UAV 200 can transmit the audio input to the computing system 400. The routing engine 420 can parse the audio voice input using the techniques discussed above.

In one example, a user can audibly recite physical objects located in the facility to the UAV 200. The UAV 200 detect the voice input and detect the physical objects included in the voice input. In some embodiments, as mentioned above, the UAV 200 can transmit the audio input to the computing system. The routing engine 420 can detect the physical objects included in the audio input. The routing engine 420 can transmit the identification of the physical objects to the UAV 200. The UAV 200 can query the physical objects database 435 to retrieve the locations of the physical objects. The UAV 200 can determine a shortest route to the locations of the physical objects. The UAV 200 can determine an order to navigate to the physical objects based on the determined order. The UAV 200 can guide the user to locations of physical objects within the facility. In some embodiments, the UAV 200 can navigate in front of the user.

The UAV 200 can navigate at a speed to stay within a specified distance from the mobile device 100. For example, upon locating the user of the mobile device (e.g., based on the image of the user), the UAV 200 can also be configured to establish a direct wireless bidirectional communication connection with the mobile device 100 of the user to facilitate receipt and transmission of data between the UAV and the mobile device 100. In one non-limiting example, to establish the communication connection, the computing system 400 can provide the mobile device 100 with an identifier associated with the UAV 200 that is coming to assist the user of the mobile device, and upon recognizing the user, the UAV can broadcast a message that can be received by the mobile device 100 and the mobile device 100 can transmit a response to the broadcast with an identifier of the mobile device. Once the mobile device 100 has the identifier of the UAV 200 and the UAV 200 has an identifier associated with the mobile device 100, the identifiers can be included in the messages transmitted by the mobile device 100 and the UAV 200.

In some embodiments, the UAV 200 can be configured to determine that the mobile device 100 remains within a specified distance of the UAV 200 while navigating to the object locations based on the direct bidirectional communication connection. For example, the UAV 200 can periodically or continuously transmit a location request message to the mobile device 100, which can be programmed to respond by transmitting its identifier. When the UAV 200 receives the response transmitted by the mobile device 100, the UAV can determine a signal strength of the transmission. In the event that the signal strength fall below a threshold, the UAV 200 can determine that the distance between the mobile device 100 and the UAV 200 is too far. In some embodiments, the UAV 200 can be configured to establish a baseline or running average signal strength of transmissions received from the mobile device 100, and can dynamically set the threshold to be the baseline signal strength, the running average signal strength, a percentage of the baseline signal strength, and/or a percentage of the running average strength. The baseline signal strength can be determined from an initial communication between the UAV 200 and mobile device 100 that is used to establish the direct wireless bidirectional communication connection between the mobile device 100 and the UAV 200.

A machine-readable element can be disposed with respect to each of the physical objects. The machine-readable element can be encoded with an identifier associated with the physical object. In response to navigating to a location of a physical object, the UAV 200 scan and decode the identifier from the machine-readable element using the reader 214, associated with the physical object. The UAV 200 can query the physical objects database 435 using the identifier, to verify the UAV 200 had navigated to the physical object requested by the user. The UAV 200 can also capture an image of the physical object to confirm the physical object was present at the location. In response to verifying the identity of the physical object and the physical object is present at the location, the UAV 200 can provide an identifier to the user that the UAV 200 has guided the user to the correct physical object. In response to being unable to verify the identity of the physical object and/or presence of the physical object at the location, the UAV 200 can transmit an alert to the mobile device 100 to be displayed on the user interface 102 and to the computing system 200. The routing engine 200 can determine a different location for the physical object and/or alert the UAV 200 the physical object is not present at the facility.

In some embodiments, the UAV 200 can navigate to each physical object, pick up the physical object from the location and deposit the physical object in a cart belonging to the user. The UAV 200 can use a picking unit to pick up the physical object and detect the cart using the image capturing device 210. In some embodiments, the UAV 200 can navigate to the physical objects and hover around the location of the physical object to wait for the user to pick up the physical object and proceed to navigating to the other requested physical objects after a specified amount of time.

In some embodiments, the UAV 200 can scan the facility as the UAV 200 navigates around the facility, using the image capturing device 210. The UAV 200 can scan for accidents and or other dangerous situations in the facility. In response to determining there is an accident or dangerous situation in the facility, the UAV 200 can reroute itself to avoid the accident and/or dangerous situation. The UAV 200 can transmit an alert to the mobile device 100 to be displayed on the user interface 102. The UAV 200 can also provide an indicator such as a light effect or audible sound in response to detecting an accident and/or dangerous situation.

In some embodiments, terminals can be disposed in the facility. The terminals can generate queues of users with multiple physical objects. Each of the terminals can have queues of different lengths. In the event, the user being guided by the UAV 200 is ready to go to a terminal, the UAV 200 can scan and decode all identifiers from all the machine-readable elements disposed on each of the physical objects in the cart of the user. In some embodiments, the UAV 200 can keep track of the physical objects picked up by the user while guiding the user around the facility. The UAV 200 can query the physical objects database 435 to retrieve information associated with the physical objects in the cart of the user. The information can include type, size, weight dimensions. The UAV 200 can also determine the quantity of physical objects in the cart based on the amount of physical objects scanned. Furthermore, the UAV 200 can capture an image of the physical objects in the cart and determine the quantity of physical objects from image analysis and/or machine vison executed on the captured image of the cart. The UAV 200 can capture images of the queues at the different terminals. The UAV 200 can determine the length of each queue at each of the different terminals based on image analysis and/or machine vision executed on the captured images of the queues at the terminals. The UAV 200 can determine the terminal with the fastest operating queue for the user based on the quantity of physical objects disposed in the cart, the information associated with the physical objects and the lengths of the queues at the terminals. The UAV 200 can transmit a recommended terminal to the mobile device 100 to be displayed on the user interface 103.

In some embodiments, the UAV 200 can be configured to scan machine-readable elements associated with physical objects from the set of physical objects disposed in a user's basket or as the physical objects are disposed in the basket associated with a user of the mobile device. The UAV can generate a list of physical objects and can transmit the list of physical objects to the computing system 400 and/or the mobile device 100. The UAV 200 can interact with the mobile device 100 and/or the computing system 400 to complete a transaction associated with the physical objects without requiring the user to bring the physical object to a terminal. For example, the mobile device 100 can be configured to display the list to the user and to provide the user with a selection interface, such that upon selection of an option in the selection interface, the mobile device transmits a message to the UAV 200 or the computing system 400 that can be utilized by the UAV 200 or the computing system 400 to complete the transaction.

The user can audibly interact with the UAV 200 while the UAV 200 is providing assistance to the user. The user can request to reroute the guidance, add more requested physical objects and/or remove certain physical objects from the original requested physical objects. The UAV 200 can provide audible or visible feedback to the user as the user is audibly interacting with the UAV 200.

As a non-limiting example, the voice activated UAV assistance system 450 can be implemented in a retail store. A customer can interact with the user interface 103 of the mobile device 100. The user interface 103 can be generated by an application executed on the mobile device 100. The mobile device 100 can transmit a request for a assistance from a UAV from to a computing system 400. The request can include a location of the mobile device 100 and a facial image of the customer. The facial image can be an image stored in a mobile device photo library. The facial image can be an image captured by the image capturing device 103. In some embodiments, the mobile device 100 can provide an identifier of the mobile device 100 to the computing system. The computing system 400 can use the identifier to track location of the mobile device 100 within the retail store. The mobile device 100 identifier can be one or more of Unique Device ID (UDID), the International Mobile Equipment Identity (IMEI), Integrated Circuit Card Identifier (ICCID) and/or the Mobile Equipment Identifier (MEID). In some embodiments, the mobile device 100 can transmit the request, via wireless access points disposed throughout the facility. The computing system 400 can determine the location of the mobile device 100 based on the proximity of the mobile device to the wireless access points.

The computing system 400 can execute the routing engine 420 in response to receiving the request. The routing engine 420 can determine a UAV 200 closest in proximity to the location of the mobile device 100. The routing engine 420 can instruct the UAV 200 to assist the customer. The instructions can include a facial image of the customer received with the request and a location of the mobile device 100 of the customer. The routing engine 420 can constantly update the UAV 200 of the current location of the mobile device 100 within the retail store.

The UAV 200 can navigate to the estimated location of the mobile device 100. The UAV 200 can scan the estimated location using the image capturing device 210 for the customer. The UAV 200 can capture a facial images of a customer in the location using the image capturing device 210 and compare the captured facial images of the customer with the facial images received in the instructions to identify and verify the customer. The UAV 200 can use image analysis and/or machine vision to compare the captured facial image of the customer and the facial received by the computing system 400. The UAV 200 can use one or more techniques of machine vision: Stitching/Registration, Filtering, Thresholding, Pixel counting, Segmentation, Inpainting, Edge detection, Color Analysis, Blob discovery & manipulation, Neural net processing, Pattern recognition, Barcode Data Matrix and “2D barcode” reading, Optical character recognition and Gauging/Metrology. In response to, identifying and verifying the customer the UAV 200 can provide an indicator to the customer that the UAV 200 is ready to provide assistance. The indicator can be an audible sound generated through the speakers 206 or a light effect generated through the light source 216. In the event the UAV 200 is unable to identify and/or verify the customer. The UAV 200 can provide a different indicator. The UAV 200 can also transmit an alert to the mobile device 100 to be displayed on the user interface. Furthermore, the UAV 200 can transmit an alert to the computing system 200.

In response to verifying and identifying the customer, the customer can audible speak and interact with the UAV 200 via the microphone 210. The UAV 200 can detect the audio voice input, parse the audio voice input and trigger an action based on the audio input. The UAV 200 can use voice/audio recognition techniques to parse the audio input. The UAV 200 can use acoustic and linguistic modeling to execute the speech, voice or audio recognition. In some embodiments, the UAV 200 can transmit the voice input to the computing system 400. The routing engine 420 can use voice/audio recognition techniques as described above to parse the audio input.

In one example, a customer can audibly recite products located in the retail store to the UAV 200. The UAV 200 detect the voice input and detect the products included in the voice input. In some embodiments, as mentioned above, the UAV 200 can transmit the audio input to the computing system 400. The routing engine 420 can detect the products included in the audio input. The routing engine 420 can transmit the identification of the products to the UAV 200. The UAV 200 can query the physical objects database 435 to retrieve the locations of the products. The UAV 200 can determine a shortest route to the locations of the products. The UAV 200 can determine an order to navigate to the products based on the determined order. The UAV 200 can guide the customer to locations of products within the retail store. In some embodiments, the UAV 200 can navigate in front of the customer. The UAV 200 can detect the location of the mobile device 100. The UAV 200 can navigate at a speed to stay within a specified distance from the mobile device 100 based on the location of the mobile device 100.

A machine-readable element can be disposed with respect to each of the products. The machine-readable element can be encoded with an identifier associated with the product. In response to navigating to a location of a product, the UAV 200 scan and decode the identifier from the machine-readable element using the reader 214, associated with the product. The UAV 200 can query the physical objects database 435 using the identifier, to verify the UAV 200 had navigated to the product requested by the customer. The UAV 200 can also capture an image of the product to confirm the product was present at the location. In response to verifying the identity of the product and the product is present at the location, the UAV 200 can provide an identifier to the customer that the UAV 200 has guided the customer to the correct product. In response to being unable to verify the identity of the product and/or presence of the product at the location, the UAV 200 can transmit an alert to the mobile device 100 to be displayed on the user interface 102 and to the computing system 200. The routing engine 200 can determine a different location for the product and/or alert the UAV 200 the product is not present at the retail store.

In some embodiments, the UAV 200 can navigate to each product, pick up the product from the location and deposit the product in a cart belonging to the customer. The UAV 200 can use a picking unit to pick up the product and detect the cart using the image capturing device 210. In some embodiments, the UAV 200 can navigate to the products and hover around the location of the product to wait for the customer to pick up the product and proceed to navigating to the other requested products after a specified amount of time.

In some embodiments, the UAV 200 can scan the retail store as the UAV 200 navigates around the retail store, using the image capturing device 210. The UAV 200 can scan for accidents and or other dangerous situations in the retail store. In response to determining there is an accident or dangerous situation in the retail store, the UAV 200 can reroute itself to avoid the accident and/or dangerous situation. The UAV 200 can transmit an alert to the mobile device 100 to be displayed on the user interface 102. The UAV 200 can also provide an indicator such as a light effect or audible sound in response to detecting an accident and/or dangerous situation.

In some embodiments, checkout terminals can be disposed in the retail store. The terminals can generate queues of customers with multiple products. Each of the checkout terminals can have queues of different lengths and operating at different speeds. In the event, the customer being guided by the UAV 200 is ready to go to a checkout terminal, the UAV 200 can scan and decode all identifiers from all the machine-readable elements disposed on each of the products in the cart of the customer. In some embodiments, the UAV 200 can keep track of the products picked up by the customer while guiding the customer around the retail store. The UAV 200 can query the physical objects database 435 to retrieve information associated with the products in the cart of the customer. The information can include type, size, weight dimensions. The UAV 200 can also determine the quantity of products in the cart based on the amount of products scanned. Furthermore, the UAV 200 can capture an image of the products in the cart and determine the quantity of products from image analysis and/or machine vison executed on the captured image of the cart. The UAV 200 can capture images of the queues at the different checkout terminals. The UAV 200 can determine the length of each queue at each of the different check out terminals based on image analysis and/or machine vision executed on the captured images of the queues at the terminals. The UAV 200 can determine the checkout terminal with the fastest operating queue for the customer based on the quantity of products disposed in the cart, the information associated with the products and the lengths of the queues at the terminals. The UAV 200 can transmit a recommended checkout terminal to the mobile device 100 to be displayed on the user interface 103.

The customer can audibly interact with the UAV 200 while the UAV 200 is providing assistance to the customer. The customer can request to reroute the guidance, add more requested products and/or remove certain products from the original requested products. The UAV 200 can provide audible or visible feedback to the customer as the customer is audibly interacting with the UAV 200.

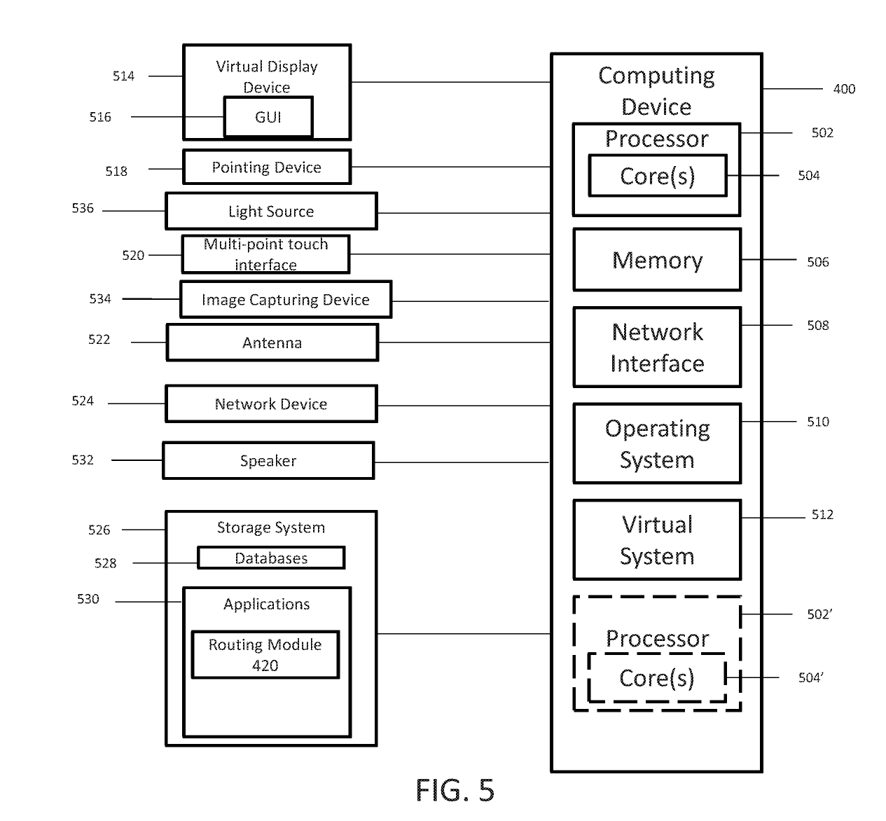

FIG. 5 is a block diagram of an example computing device for implementing exemplary embodiments of the present disclosure. Embodiments of the computing device 400 can implement embodiments of the voice activated UAV assistance system. The computing device 400 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing device 400 may store computer-readable and computer-executable instructions or software (e.g., applications 530 such as the routing engine 420) for implementing exemplary operations of the computing device 400. The computing device 400 also includes configurable and/or programmable processor 502 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for implementing exemplary embodiments of the present disclosure. Processor 502 and processor(s) 502′ may each be a single core processor or multiple core (504 and 504′) processor. Either or both of processor 502 and processor(s) 502′ may be configured to execute one or more of the instructions described in connection with computing device 400.

Virtualization may be employed in the computing device 400 so that infrastructure and resources in the computing device 400 may be shared dynamically. A virtual machine 512 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing device 400 through a visual display device 514, such as a computer monitor, which may display one or more graphical user interfaces 516, multi touch interface 520, a pointing device 518, a reader 532, a light source 533, image capturing device 534 and a microphone 535 and a speaker system 537.

The computing device 400 may also include one or more storage devices 526, such as a hard-drive, CD-ROM, or other computer readable media, for storing data and computer-readable instructions and/or software that implement exemplary embodiments of the present disclosure (e.g., applications such as the routing engine 420). For example, exemplary storage device 526 can include one or more databases 528 for storing information associated information associated with physical objects. The databases 528 may be updated manually or automatically at any suitable time to add, delete, and/or update one or more data items in the databases.

The computing device 400 can include a network interface 508 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 522 to facilitate wireless communication (e.g., via the network interface) between the computing device 400 and a network and/or between the computing device 400 and other computing devices. The network interface 508 may include a built-in network adapter, network interface card, PCMCIA network card, card bus network adapter, wireless network adapter, USB network adapter, modem or any other device suitable for interfacing the computing device 400 to any type of network capable of communication and performing the operations described herein.

The computing device 400 may run any operating system 510, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 400 and performing the operations described herein. In exemplary embodiments, the operating system 510 may be run in native mode or emulated mode. In an exemplary embodiment, the operating system 410 may be run on one or more cloud machine instances.

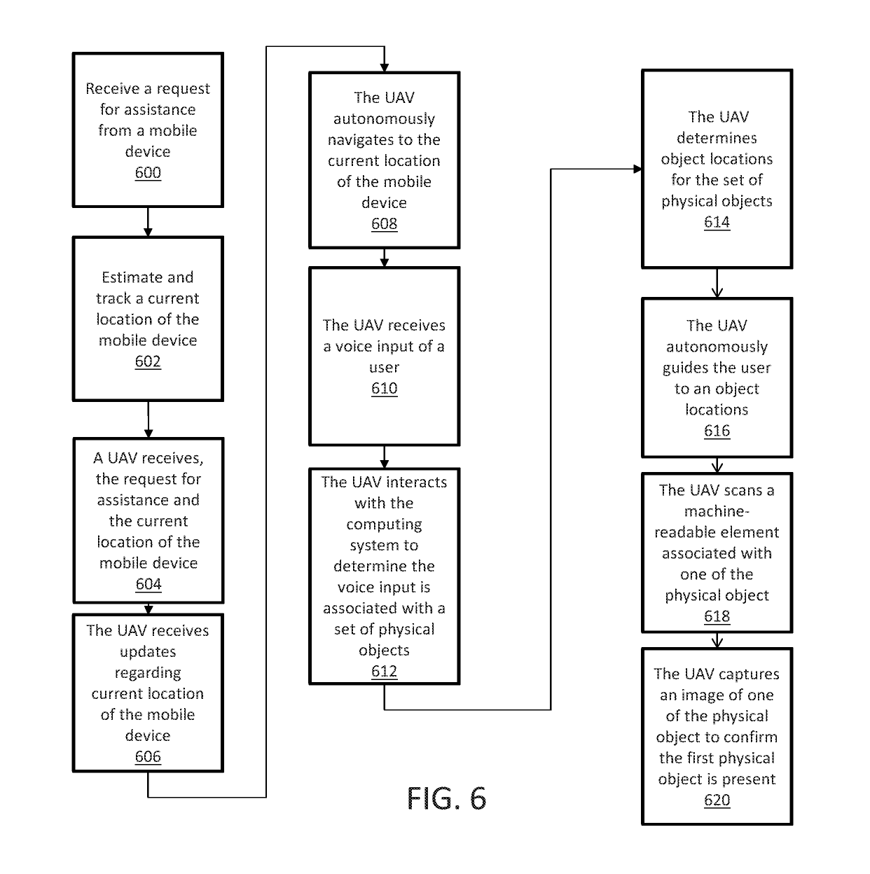

FIG. 6 is a flowchart illustrating an exemplary process performed by an voice activated UAV assistance system in an exemplary embodiment. In operation 600, in operation a computing system (e.g. computing system 400 as shown in FIG. 4) can receive a request for assistance from a mobile device (e.g. mobile device 100 as shown in FIGS. 1, 2 and 4) via one or more wireless access points. In operation 602, the computing system can estimate and track a current location of the mobile device based on an interaction between the mobile device and the one or more wireless access points. In operation 604, a UAV, including an inertial navigation system (e.g. inertial navigation system 212 as shown in FIG. 2), a microphone (e.g. microphone 206 as shown in FIGS. 2 and 4), an image capturing device (e.g. image capturing device 210 as shown in FIGS. 2 and 4), and a scanner (e.g. scanner 214 as shown in FIGS. 2 and 4) can receive, the request for assistance and the current location of the mobile device from the computing system. In operation 606, the UAV can receive updates from the computing system associated with the current location of the mobile device as the mobile device moves through the facility. In operation 608, the UAV can autonomously navigate to the current location of the mobile device. In operation 610, the UAV can receive a voice input of a user associated with the mobile device via the microphone. In operation 612, the UAV can interact with the computing system to determine the voice input is associated with a set of physical objects disposed in the facility. In operation 614, the UAV can determine object locations for the set of physical objects in the facility. In operation 616, the UAV can autonomously guide the user to an object locations physical objects in the facility. The UAV can confirm the mobile device remains within a specified distance of the UAV while navigating around the facility. In operation 618, the UAV can scan a machine-readable element associated with one of the physical object. In operation 620, the UAV can capture using the image capturing device, an image of one of the physical object to confirm the first physical object is present at the object location.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A voice activated Unmanned Aerial Vehicle (UAV) assistance system in a facility, the system comprising:
a computing system located in a facility configured to receive a request for assistance from a mobile device via one or more wireless access points and to estimate and track a current location of the mobile device based on an interaction between the mobile device and the one or more wireless access points;
a UAV including an inertial navigation system, a microphone, an image capturing device, and a scanner, the UAV is configured to:
receive the request for assistance and the current location of the mobile device from the computing system;
receive updates from the computing system associated with the current location of the mobile device as the mobile device moves through the facility;
autonomously navigate to the current location of the mobile device;
receive a voice input of a user associated with the mobile device via the microphone;
interact with the computing system to determine the voice input is associated with a set of physical objects disposed in the facility;
determine object locations for the set of physical objects in the facility;
autonomously guide the user to an object location of at least a first physical object in the set of physical objects in the facility, wherein the UAV confirms the mobile device remains within a specified distance of the UAV while navigating to the object location of the at least first physical object;
scan, via the scanner, a machine-readable element associated with the at least first physical object; and
capture, via the image capturing device, an image of the at least first physical object to confirm the first physical object is present at the object location.

2. The system of claim 1, wherein the UAV is configured to autonomously guide the user to another object location associated with at least a second physical object of the set of physical objects in the facility, wherein the at least one UAV confirms the mobile device is within a specified distance of the at least one UAV while navigating to the other object location associated with the at least second physical object.

3. The system in claim 1, further comprising a plurality of terminals disposed in the facility.

4. The system of claim 3, wherein the UAV is configured to:
scan machine-readable elements associated with physical objects from the set of physical objects disposed in a basket associated with a user of the mobile device;
capture one or more images of each of the plurality of terminals;
calculate a time each terminal would take to process the physical objects associated with the scanned machine-readable elements, based on the scanned machine-readable elements and the captured one or more images; and
transmit a recommendation of at least one terminal to the mobile device based on the calculated time each terminal would take to process the physical objects associated with the scanned machine-readable elements.

5. The system in claim 4, wherein the mobile device is configured to display the recommendation of at least one terminal on the interactive display.

6. The system in claim 1, wherein the UAV is configured to:
capture images of the facility while navigating to the object location;
detect an accident in the facility based on the images; and
transmit an alert to the mobile device, in response to detecting the accident.

7. The system in claim 6, wherein the mobile device is configured to display the alert on the interactive display.

8. The system in claim 6, wherein an accident is one or more of: a spill, glass breakage, slippery floors, fire and other dangerous conditions.

9. The system of claim 6, wherein the UAV modifies a route to the object location in response to detecting the accident.

10. The system in claim 1, wherein the UAV is configured to:
pick up the first physical object of the set of physical objects in response to confirming the first physical object is present at the object location; and
deposit the first physical object in a basket associated with a user of the mobile device.

11. The system of claim 1, wherein the request for assistance includes a first image of a face of the user of the mobile device.

12. The system of claim 11, wherein the UAV is configured to:
capture verification images of faces after autonomously navigating to the current location of the mobile device within the facility; and
determining whether one of the verification images of the faces captured by the UAV at the current location corresponds to the face of the user of the mobile device who transmitted the request based on a comparison of the verification images with the first image of the face of the user of the mobile device included in the request.

13. The system of claim 11, wherein the UAV is configured to:
identify the user based on the comparison; and
provide an indicator to the user that the UAV is ready to assist the user.

14. The system of claim 13, wherein the UAV is configured to:
establish a direct communication connection with the mobile device of the user to facilitate receipt and transmission of data between the UAV and the mobile device.

15. The system of claim 13, wherein the UAV is configured to determine that the mobile device remains within a specified distance of the UAV while navigating to the object location based on the communication connection.

16. A method for implementing voice activated Unmanned Aerial Vehicle (UAV) assistance in a facility, the method comprising:
receiving, via a computing system located in a facility, a request for assistance from a mobile device via one or more wireless access points;
estimating and tracking, via the computing system, a current location of the mobile device based on an interaction between the mobile device and the one or more wireless access points;
receiving, via a UAV including an inertial navigation system, a microphone, an image capturing device, and a scanner, the request for assistance and the current location of the mobile device from the computing system;
receiving, via the UAV, updates from the computing system associated with the current location of the mobile device as the mobile device moves through the facility;
autonomously navigating, via the UAV, to the current location of the mobile device;
receiving, via the UAV, a voice input of a user associated with the mobile device via the microphone;
interacting, via the UAV with the computing system to determine the voice input is associated with a set of physical objects disposed in the facility;
determining, via the UAV, object locations for the set of physical objects in the facility;
autonomously guiding, via the UAV, the user to an object location of at least a first physical object of the set of physical objects in the facility, wherein the UAV confirms the mobile device remains within a specified distance of the UAV while navigating to the first object location of the at least first physical object;
scanning, via the UAV, via the scanner, a machine-readable element associated with the at least first physical object; and
capturing, via the UAV, via the image capturing device, an image of the at least first physical object to confirm the first physical object is present at the object location.

17. The method of claim 16, further comprising:
autonomously guiding, via the UAV, the user to another object location of at least a second physical object of the set of physical objects in the facility, wherein the at least one UAV confirms the mobile device is within a specified distance of the at least one UAV while navigating to the other object location associated with the at least second physical object.

18. The method of claim 17, further comprising:
scanning, via the UAV, machine-readable elements associated with physical objects from the set of physical objects disposed in a basket associated with a user of the mobile device;
capturing, via the UAV, one or more images of each of the plurality of terminals;
calculating, via the UAV, a time each terminal would take to process the physical objects associated with the scanned machine-readable elements, based on the scanned machine-readable elements and the captured one or more images;
transmitting, via the UAV, a recommendation of at least one terminal of a plurality of terminals are disposed in the facility to the mobile device based on the calculated time each terminal would take to process the physical objects associated with the scanned machine-readable elements; and
displaying, via the mobile device, the recommendation of at least one terminal on the interactive display.

19. The method in claim 15, further comprising:
capturing, via the UAV, images of the facility while navigating to the object location; and
detecting, via the UAV, an accident in the facility based on the images;
modifying, via the UAV, a route to the object location in response to detecting the accident;
transmitting, via the UAV, an alert to the mobile device, in response to detecting the accident; and
displaying, via the mobile device, the alert on the interactive display.

20. The method of claim 16, further comprising:
capturing, via the UAV, verification images of faces after autonomously navigating to the current location of the mobile device within the facility;
determining, via the UAV, whether one of the verification images of the faces captured by the UAV at the current location corresponds to the face of the user of the mobile device who transmitted the request based on a comparison of the verification images with a first image of the face of the user of the mobile device included in the request.
identifying, via the UAV, the user based on the comparison;
providing, via the UAV, an indicator to the user that the UAV is ready to assist the user;
establishing, via the UAV, a direct communication connection with the mobile device of the user to facilitate receipt and transmission of data between the UAV and the mobile device; and
determining, via the UAV, that the mobile device remains within a specified distance of the UAV while navigating to the object location based on the communication connection.
